(19) United States
(12) Patent Application Publication
(10) Pub. No.: US 2021/0340770 A1
(43) Pub. Date: Nov. 4, 2021

(54) DEVICES AND METHODS FOR DIVERTING WATER FROM A DOWNSPOUT

(71) Applicant: SMARTMRP Inc., Alfred (CA)

(72) Inventor: James Buhler, Cranbrook (CA)

(21) Appl. No.: 17/306,565

(22) Filed: May 3, 2021

Related U.S. Application Data
(60) Provisional application No. 63/019,175, filed on May 1, 2020.

(51) Int. Cl. E04D 13/08

(52) U.S. Cl. CPC E04D 13/08; E04D 2013/0813

(57) ABSTRACT

Devices and methods for diverting water from a downspout are described herein. The devices include a body having at least one outer side wall, a top end having a top opening configured to couple to an upper portion of downspout and a bottom end having a bottom opening configured to couple to a lower portion of downspout. The device also includes an outlet extending through one of the outer side walls. The outlet is configured to provide for the water to flow through the outer side wall. The device also includes a collecting surface positioned between the top end and the bottom end of the body. The collecting surface extends inwardly from the outer side walls beneath the outlet. The device also includes an inner body having one or more inner side walls inwardly spaced from the outer side wall.

### CROSS-REFERENCE

The present application claims the benefit of U.S. Provisional Patent Application No. 63/019,175 entitled Devices and Methods for Diverting Water from a Downspout, filed on May 1, 2020, the contents of which are incorporated herein by reference.

### FIELD

The embodiments disclosed herein relate to devices and methods for diverting water, and more specifically to devices and methods for diverting water from a downspout.

### BACKGROUND

Rain water collected from a roof into a rain barrel or a cistern can be used for watering yards and gardens. Currently, water diverters that attach to a downspout are used to divert water to a barrel or other water collection container. However, there are several disadvantages to using current water diverters, particularly for uses other than diverting water to a rain barrel or other collecting device.

For instance, using existing diverters for diverting water to a rain barrel can become problematic once the rain barrel is full. When this occurs, water can flow out of the barrel and cause problems with flooding the area surrounding the rain barrel and even the building to which the downspout is attached. Additional problems associated with collecting rain water in rain barrels include issues with the rain barrel not being properly secured to a building to which a downspout feeding the rain barrel is attached, the need for winter maintenance, especially in climates with freezing temperatures, and where the rain water collection systems are not closed systems, bugs can be attracted to the water, carry disease and cause irritation to nearby humans. Further, it can be difficult to use existing diverters to carry water to several locations, particularly to locations that are elevated relative to the rain barrel.

Accordingly, there is a need for new devices and methods for diverting water from a downspout, and particular for diverting water from a downspout for providing the water to other areas around the downspout, such as but not limited to areas that may not directly receive rain water.

### SUMMARY

In one broad aspect, a device for diverting water from a downspout is described herein. The device includes a tubular body having: two pairs of opposing outer side walls defining a first cavity therein; a top end having a top opening configured to couple to an upper portion of downspout to receive the water from the upper portion of downspout into the first cavity; a bottom end having a bottom opening configured to couple to a lower downspout to provide for at least a portion of the water to flow into the lower downspout; at least one outlet extending outwardly through one of the outer side walls, the outlet configured to provide for at least a portion of the water to flow laterally out of the first cavity and through one of the side walls; an inner collecting surface positioned between the top end and the bottom end of the tubular body, the inner collecting surface extending inwardly from each of the outer side walls of the body beneath the at least one outlet; and an inner tubular body having inner side walls inwardly spaced from the outer side walls of the tubular body, the inner side walls extending upwardly from the inner collecting surface to a height above the at least one outlet, the inner tubular body defining a second cavity to provide for water to flow from the top opening to the bottom opening and out of the tubular body.

In at least one embodiment, the inner side walls extend upwardly beyond a height of the outer side walls.

In at least one embodiment, the collecting surface extends around the inner body.

In at least one embodiment, the tubular body has a shape that mimics a shape of the downspout.

In at least one embodiment, the body further includes a crown coupled to the inner side walls, the crown being configured to divert water towards the collecting surface.

In at least one embodiment, the crown inhibits water from passing directly from the top opening to the second cavity.

In at least one embodiment, the crown directs water into the first cavity.

In at least one embodiment, the inner side walls include at least one aperture to direct water from the first cavity to the second cavity.

In at least one embodiment, the at least one aperture is positioned vertically above the at least one outlet.

In at least one embodiment, the device further includes three outlets, each outlet including a fixture for receiving an end of a hose.

In at least one embodiment, the tubular body has a rectangular shape.

In at least one embodiment, the inner body has a rectangular shape.

In at least one embodiment, the inner side walls are outwardly sloped to taper a shape of the inner cavity.

In at least one embodiment, the inner side walls are outwardly sloped toward an inner surface of the outer side walls along half of their length.

In at least one embodiment, the device also includes a filter positioned within the inner cavity.

In at least one embodiment, the filter includes a platform configured to provide for water to pass therethrough and to inhibit debris from passing therethrough and one or more posts configured to support the platform at a position above the one or more outlets to inhibit the debris from passing through the one or more outlets.

In another broad aspect, a method of diverting water from a downspout is described herein. The method includes receiving water in a water diverter from a downspout, the downspout being fluidly coupled to the water diverter; collecting water on a collecting surface of the water diverter, the collecting surface being positioned beneath an outlet in a side wall of the water diverter; and directing the water out of the outlet of the water diverter.

In another broad aspect, a device for diverting water from a downspout is described herein. The device includes a body having at least one outer side wall; a top end having a top opening configured to couple to an upper portion of downspout to receive the water from the upper portion of downspout into a first cavity of the body; a bottom end having a bottom opening configured to couple to a lower portion of downspout; at least one outlet extending outwardly through the outer side wall, the outlet configured to provide for at least a portion of the water to flow laterally out of the first cavity and through the side wall; a collecting surface positioned between the top end and the bottom end of the body, the collecting surface extending inwardly from the outer side wall beneath the at least one outlet; and an inner body having one or more inner side walls inwardly spaced from the outer side wall, the one or more inner side walls extending upwardly from the collecting surface above the at least one outlet, the one or more inner side walls, the outer side wall and the collecting surface forming the first cavity to divert the water away from the lower portion of the downspout and towards the at least one outlet.

In at least one embodiment, the collecting surface is a bottom surface of the first cavity.

In at least one embodiment, the collecting surface extends around at least two side walls of the inner body.

In at least one embodiment, the body further comprises a crown configured to direct water travelling downwardly from the upper portion of downspout towards the collecting surface.

In at least one embodiment, the crown is configured to direct water travelling downwardly from the upper portion of downspout into the first cavity.

In at least one embodiment, the crown is configured to inhibit water travelling downwardly from the upper portion of downspout from passing directly into the lower portion of downspout.

In at least one embodiment, the crown extends inwardly from at least one of the outer side walls.

In at least one embodiment, the inner body has three inner side walls inwardly spaced from respective outer side walls of the body.

In at least one embodiment, the device has three outlets, each outlet including a fixture for receiving an end of a hose.

In at least one embodiment, the body has a rectangular shape.

In at least one embodiment, the inner body has a rectangular shape.

In at least one embodiment, the device includes a filter configured to fit within the first cavity and inhibit debris from entering the at least one outlet.

In at least one embodiment, the filter includes a platform configured to provide for water to pass therethrough and inhibit debris from passing therethrough and one or more posts configured to support the platform at a position above the one or more outlets to inhibit the debris from entering the one or more outlets.

In at least one embodiment, the inner body defines a second cavity fluidly coupled to the first cavity and the lower portion of the downspout, the second cavity providing for water to pass from the first cavity and out of the device through the lower portion of the downspout.

In at least one embodiment, the inner side walls of the inner body separate the first cavity from the second cavity.

In at least one embodiment, the body includes a first member and a second member that is couplable to the first member.

In at least one embodiment, the collecting surface is perpendicular to the inner side walls.

In at least one embodiment, the collecting surface is perpendicular to the outer side walls.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a picture of a front view of a downspout water diverter, according to one embodiment.

FIG. 2 is a picture of a front perspective view of the downspout water diverter of FIG. 1.

FIG. 3 is a picture of a top down view of the downspout water diverter of FIG. 1.

FIG. 4 is a picture of a rear view of the downspout water diverter of FIG. 1.

FIG. 5 is a picture of side perspective view a downspout water diverter, according to another embodiment.

FIG. 6 is a picture of front perspective view a downspout water diverter, according to another embodiment.

FIG. 7 is a picture of an exploded view of the downspout water diverter of FIG. 6.

FIG. 8 is a side view of a downspout water diverter, according to another embodiment.

FIG. 9 is a front perspective view of the downspout water diverter of FIG. 8.

FIG. 10 is a top down view of the downspout water diverter of FIG. 8.

FIG. 11 is a side view of a downspout water diverter, according to another embodiment.

FIG. 12 is a front view a downspout water diverter, according to another embodiment.

FIG. 13 is a front view of a downspout water diverter, according to another embodiment.

FIG. 14 is a side view of the downspout water diverter of FIG. 13.

FIG. 15A is a cross-sectional view of a downspout diverter, according to at least one embodiment described here.

FIG. 15B is a front view of a filter of a downspout diverter described herein, according to at least one embodiment described here.

FIG. 16 is a top down view of the filter of FIG. 15B.

Further aspects and features of the example embodiments described herein will appear from the following description taken together with the accompanying drawings.

### DETAILED DESCRIPTION

Various devices and methods are described below to provide an example of at least one embodiment of the claimed subject matter. No embodiment described below limits any claimed subject matter and any claimed subject matter may cover devices and methods that differ from those described below. The claimed subject matter are not limited to devices and methods having all of the features of any one device or method described below or to features common to multiple or all of the devices and methods described below. It is possible that a device or method described below is not an embodiment of any claimed subject matter. Any subject matter that is disclosed in a device or method described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It will be appreciated that for simplicity and clarity of illustration, where considered appropriate, reference numerals can be repeated among the figures to indicate corresponding or analogous elements. Further, reference numerals

The following description is not intended to limit or define any claimed or as yet unclaimed subject matter. Subject matter that may be claimed may reside in any combination or sub-combination of the elements or process steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

Recently, there has been a growing interest in developing devices and methods for diverting water from a downspout. Generally, the downspout water diverters described herein are configured to divert or transfer water passing downwardly through a downspout (e.g. from an eavestrough) outwardly from the downspout. For instance, the downspout water diverters described herein may be configured to divert water from the downspout to a garden hose without the need for a separate connector. The garden hose may be directly passed to a landscaping feature, such as but not limited to a garden, a planter or a flower box, to water, for example, a portion of landscaping that otherwise would not receive water directly during rain. The garden hose may also be connected to a rain barrel or other type of water storage device.

In at least one embodiment, the downspout water diverters described herein can be connected to a downspout at any height of the downspout. For instance, the downspout water diverters described herein may be located adjacent to the ground or may be located at a position upwardly spaced from the ground, such as to provide water to a top of a rain barrel. In at least one embodiment, the downspout water diverters described herein can include up to three outputs that extend in three different directions relative to the diverter to provide for diverting water to several locations, for example, to hard to reach elevated growing containers under windows or on decks. Because the diverters described herein include overflow of water not used by diversion, in at least one embodiment, it is possible to mount more than one diverter at different elevations on a single down pipe to handle multiple watering requirements. Further, in at least one embodiment, the water diverters described herein are compatible with standard hose connectors to make it easy to divert water to locations that are some distance from the down pipe.

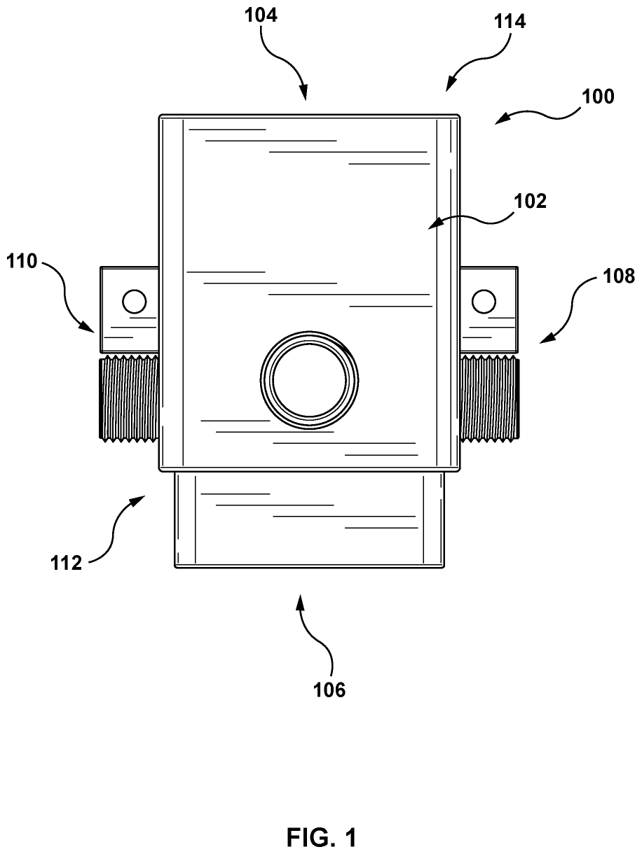

Turning to the Figures, FIG. 1 shows a picture of one embodiment of a device for diverting water from a downspout. In this embodiment, device 100 includes a tubular body 102 having a top end 104, a bottom end 106, a right side 108, a left side 110, a front side 112 and a rear side 114.

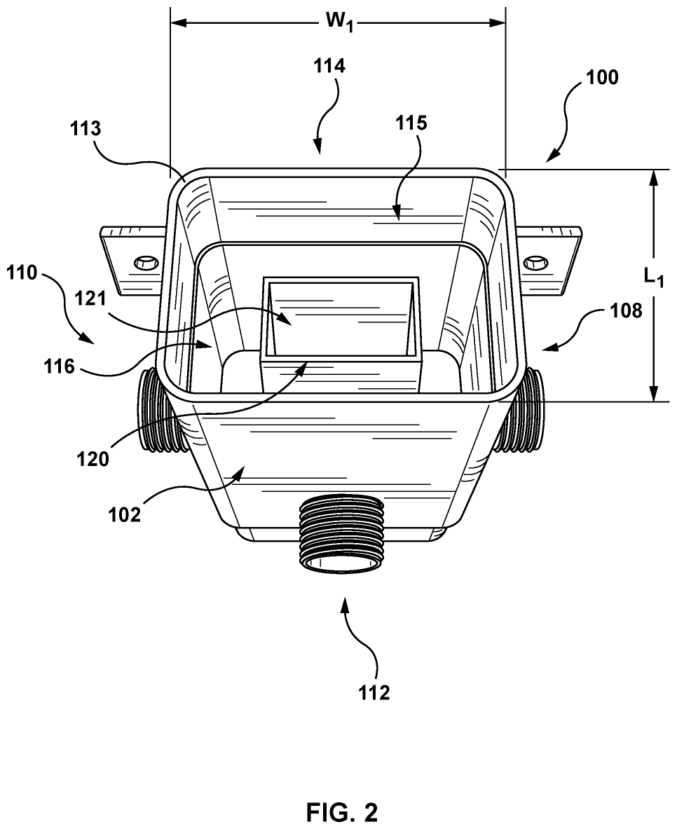

Referring now to FIG. 2, body 102 has a side wall 113 that defines a cavity 115 therein. In the embodiment shown, body 102 is generally shaped to mimic the shape of a typical water downspout. As shown in FIG. 1, body 102 has a rectangular shape with a width W₁ greater than a length L₁.

Cavity 115 is accessible by a top opening 116 on top end 104 and by a bottom opening 118 on bottom end 106. Top opening 116 is generally shaped to receive a water downspout therein and bottom opening 118 is generally shaped to snugly insert into a water downspout.

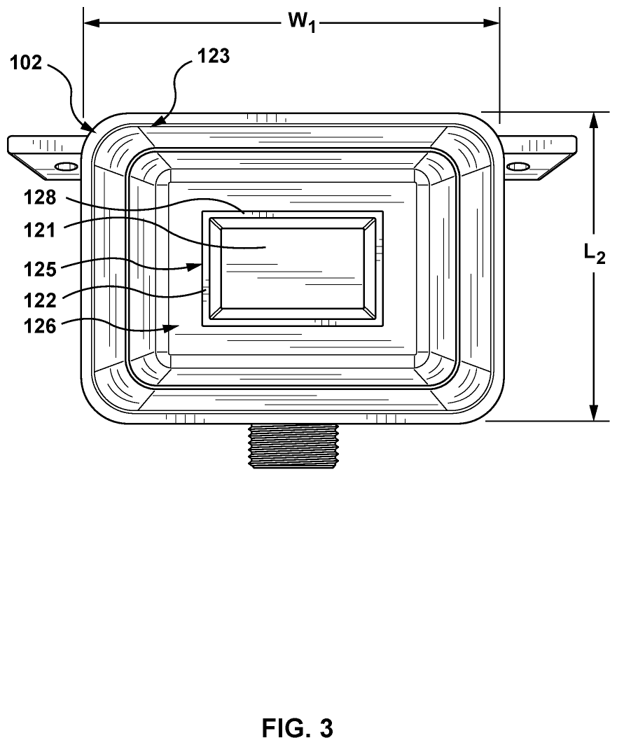

FIG. 2 also shows that body 102 includes an inner tubular body 120 is housed within the cavity 115. Inner body 120 has a rectangular shape and includes an inner side wall 122 that defines an inner cavity 124. As shown in FIG. 3, inner body 120 has a rectangular shape with a width W₂ greater than a length L₂. Inner cavity 124 is accessible by a top inner opening 121 and by a bottom inner opening (not shown). Top inner opening 121 may have any shape and generally provides for water to pass from cavity 115 to inner cavity 124, such as in instances where the device 100 is not diverting water out of the downspout, or instances where the amount of water passing through the device 100 exceeds the diverting capacity of the device 100.

Inner side wall 122 has an outer surface 125 and side wall 113 has an inner surface 123. Outer surface 125 of inner side wall 122 is coupled to inner surface 121 of side wall 113 by a collecting surface 126 (as shown in FIG. 3.). Collecting surface 126 extends (e.g. horizontally) between the outer surface 125 of side wall 122 and the inner surface 121 of side wall 113 around the inner body 120 and inhibits water from passing from the top opening 116 of body 102 to bottom opening 118 without passing through the inner cavity 124.

Collecting surface 126 is positioned vertically between the top opening 116 and the bottom opening 118. Collecting surface 126 is positioned vertically between along a height of the inner cavity 124 (measured from the collecting surface 126 upwardly to a top edge. Collecting surface 126 is positioned vertically between a top edge 128 of the inner body 121 and the bottom opening 118. Water that is collected by the collecting surface 126 may exit the device 100 by passing though one of one or more outlets 130 in the side wall 113 of the body 102. If the device 100 is not being used, a cap may be placed on the one or more outlets 130 and water collected by the collecting surface 126 may exit the device 100 by passing though the inner cavity 124, out the bottom opening 118 and through the lower portion of the downspout.

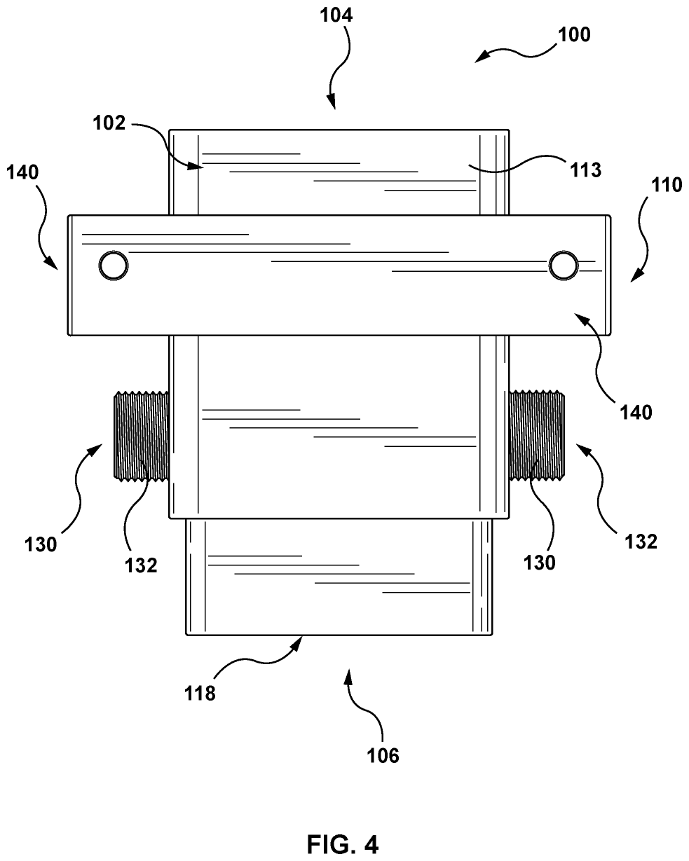

As shown in FIG. 4, the one or more outlets 130 may include a fitting 132. Fitting may include but is not limited to a threaded portion 132 for receiving an end of a hose.

As also shown in FIG. 4, body 102 may also include mounting portions 140. In device 100, the mounting portions 140 are shown on rear side 114 extending laterally from the side wall 113.

It will be appreciated that for simplicity and clarity of illustration, where considered appropriate, reference numerals can be repeated among the figures to indicate corresponding or analogous elements. Further, reference numerals

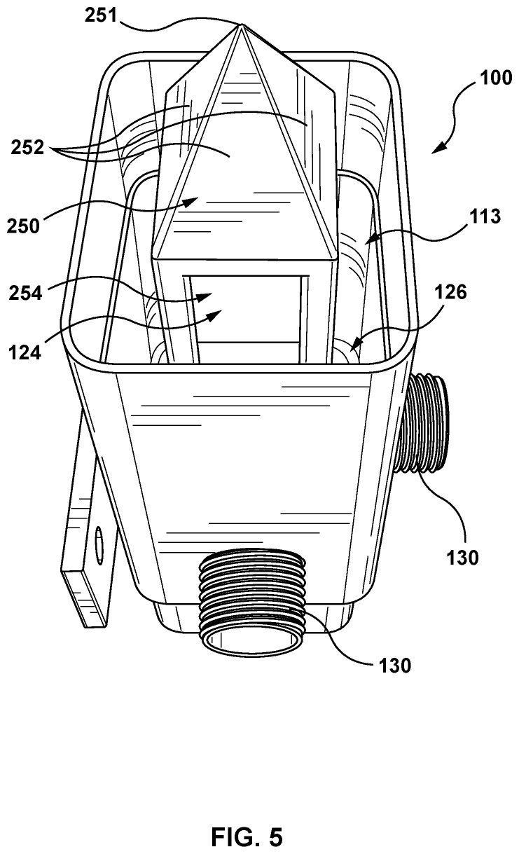

Turning to FIG. 5, illustrated therein is another view of device 100 for diverting water from a downspout. Here, device 100 is shown including a crown 250 according to at least one embodiment. Crown 250 is configured to direct water travelling downwardly from an upper downspout away from the inner cavity 124. As shown in FIGS. 1-4, water travelling downwardly through device 100 from an upper downspout may pass directly into the inner cavity 124 without contacting the collecting surface 126. To avoid this possibility, crown 250 is configured to cover inner cavity 124 and direct water travelling downwardly from the upper downspout towards the collecting surface 126.

Crown 250 can have any shape or configuration to inhibit water travelling downwardly from an upper downspout from directly entering the inner cavity 124 without being directed into inner cavity 124 by collecting surface 126. In the embodiments shown in FIGS. 5-7, crown 250 is shown as having a pyramidal shape including an apex 251 and four sides 252. To provide for water to pass from the cavity 113, where it is collected by collecting surface 126, into inner cavity 124, where it travels towards the bottom opening 118 (e.g. in times where the water is not being diverted from the downspout) the inner side walls 122 include one or more apertures 254 (can also be referred to, collectively, as top inner opening 121). Apertures 254 fluidly connect the cavity 113 to the inner cavity 124 for directing water from the top opening 116 to the bottom opening 118.

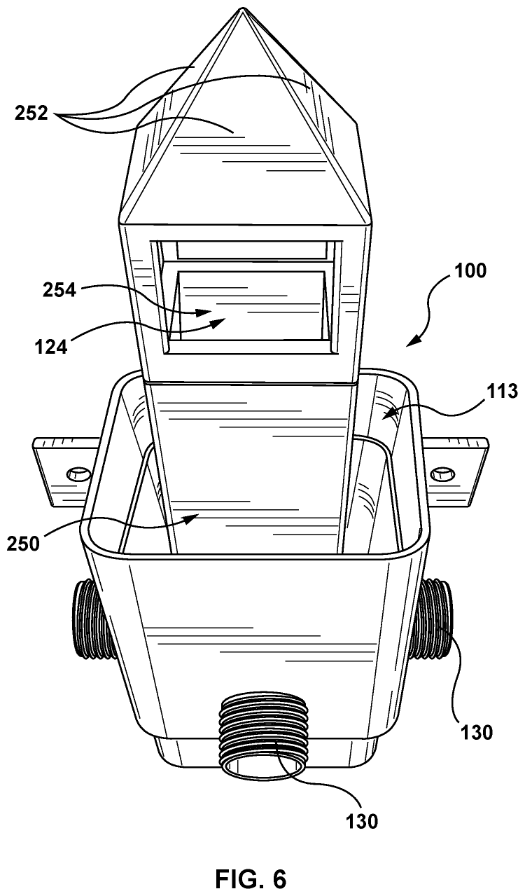

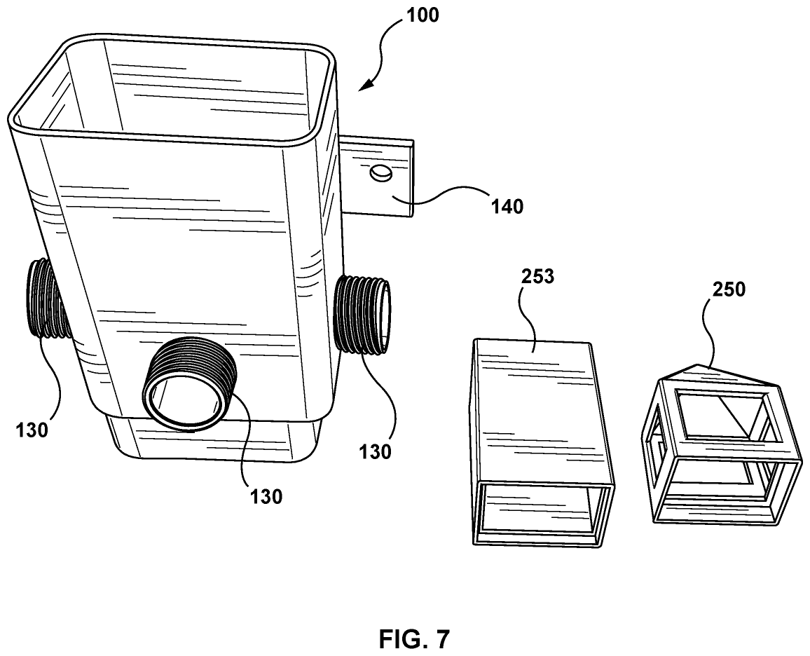

As shown in FIG. 6, the crown 250 can be vertically positioned at various heights relative to the outlets 130. In instances where a smaller volume of water is desired to be diverted, the crown 250 can be positioned within the body 102 of the device 100. In instances where a greater volume of water is desired to be diverted from the downspout, the crown 250 can be positioned outside (vertically) of the side wall 113 the body 102 of the device 100. Extension 253 (see FIG. 7) may be used to vertically space the crown 250 from the collecting surface 126. In at least one embodiment, the crown 250 and extension 253 are designed to snap into place by hand with a female portion on the top side fitting over a smaller male receptacle portion on the object below.

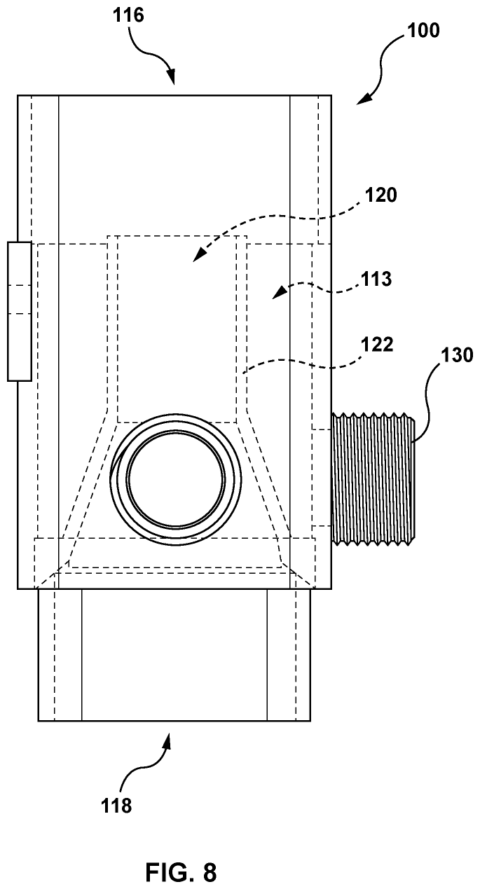

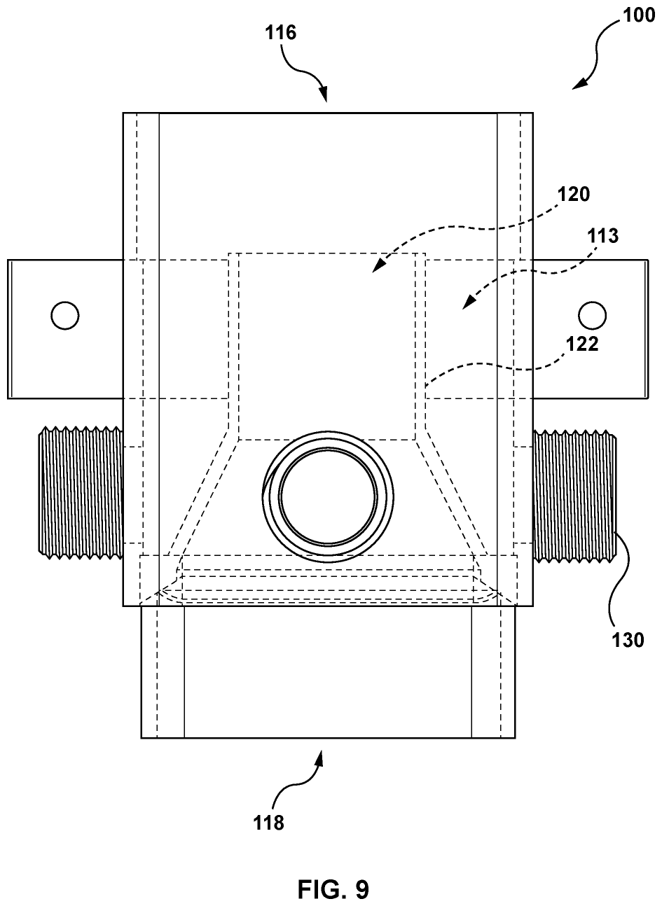

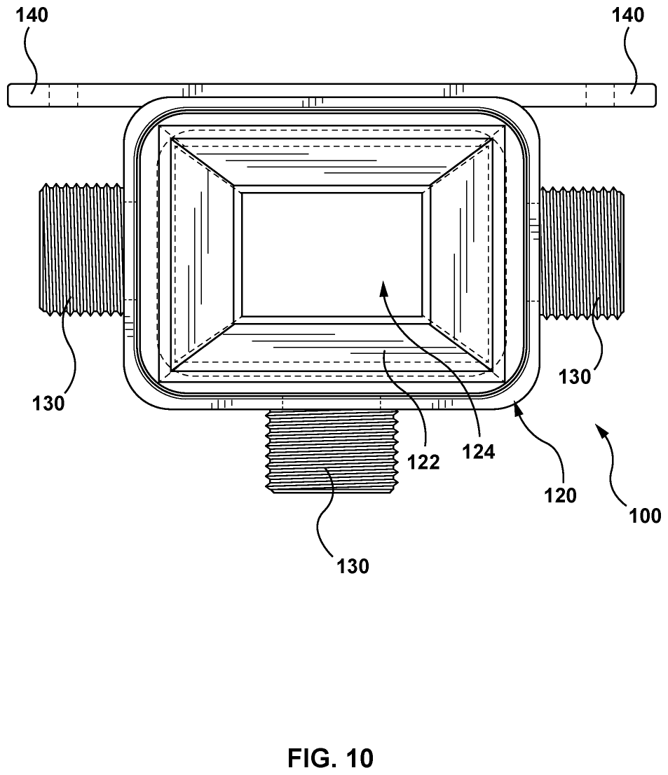

Turning to FIGS. 8-10, illustrated therein are additional view of device 100 for diverting water from a downspout showing some of the inner features described herein. As noted above, in at least one embodiment, device 100 includes an inner body 120 having inner side walls 122. In at least one embodiment, side walls 122 are configured to taper at least a portion of the shape of cavity 113 along a length of the inner side walls 122 in a direction towards the outlets 130. Inner side walls 122 may be sloped along their entire length, or may slope along a portion of their length, to taper at least a portion of cavity 113. For instance, as shown in FIGS. 9 and 10, inner side walls 122 may flare outwardly partially along their length. Inner side walls 122 are shown flaring outwardly beginning at a position approximately halfway along their length.

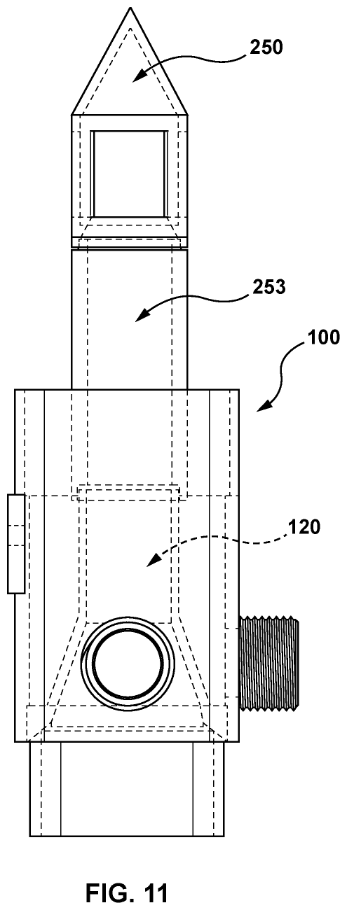

FIG. 11 shows device 100 for diverting water from a downspout including the inner body 120 of device 100 having sloped inner side walls 122 and a raised crown 250. Extension 253 is shown vertically spacing the crown 250 from the inner body 120. In at least one embodiment, adding extension 253 provides for greater capacity and pressure buildup while adding crown 250 acts to ensure that a greater portion of the water falling down the center of the down downspout, as opposed to water flowing along the walls of the downspout, will be directed to the diverter outlets 130. Further, it should be noted that the embodiment shown in FIG. 11 has a generally compact profile (e.g. the outer walls do not extend laterally from the downspout) for applications where unobtrusiveness is desired.

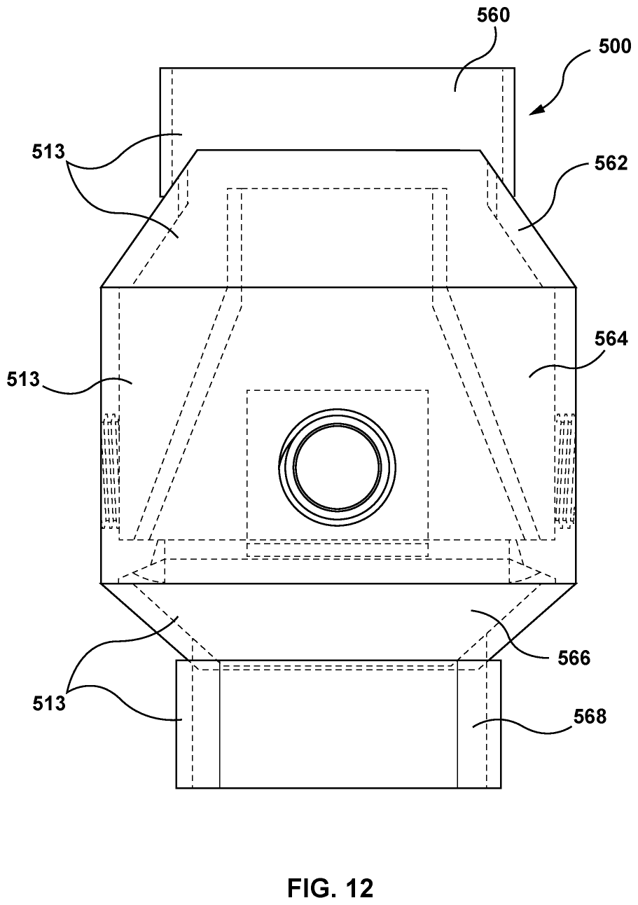

Referring now to FIGS. 12-14, shown therein are other embodiments of devices for diverting water from a downspout. In these embodiments, the bodies of the devices include side walls that are configured to increase the volume of the cavity responsible for collecting water from the downspout (relative to the volume of cavity 113 of FIG. 1). To accomplish this, these the bodies of these devices generally include side walls that are outwardly spaced from their inner side walls by distances greater than has been shown in earlier embodiments.

For instance, as shown in FIG. 12, device 500 include side walls 513 include a first upper portion 560 that couples to an upper downspout portion (not shown), a second upper portion 562 that is sloped outwardly and sloped laterally relative to the first upper portion 560, a middle portion 564 that is generally parallel to the first upper portion 560, a second lower portion 566 that is sloped inwardly and sloped medially relative to the middle portion 564, and first lower portion 568 that is generally parallel to the first upper portion 560. It should be noted that the embodiment shown in FIG. 12 has increased capacity (relative to embodiments described above), which provides for greater water pressure buildup on the diverter outlets 130. The embodiment shown in FIG. 12 also provides for a larger overflow opening for heavy rainfall applications.

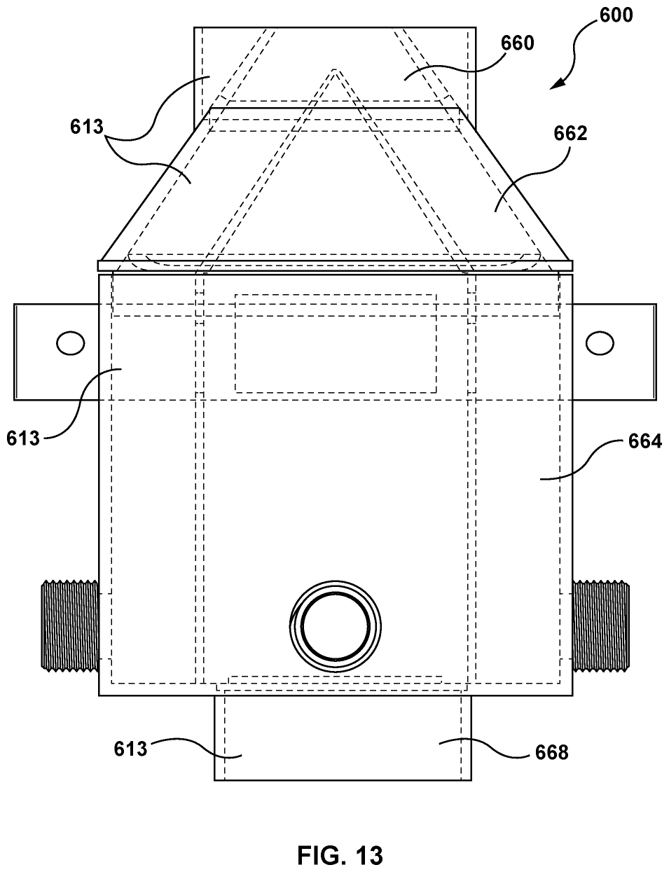

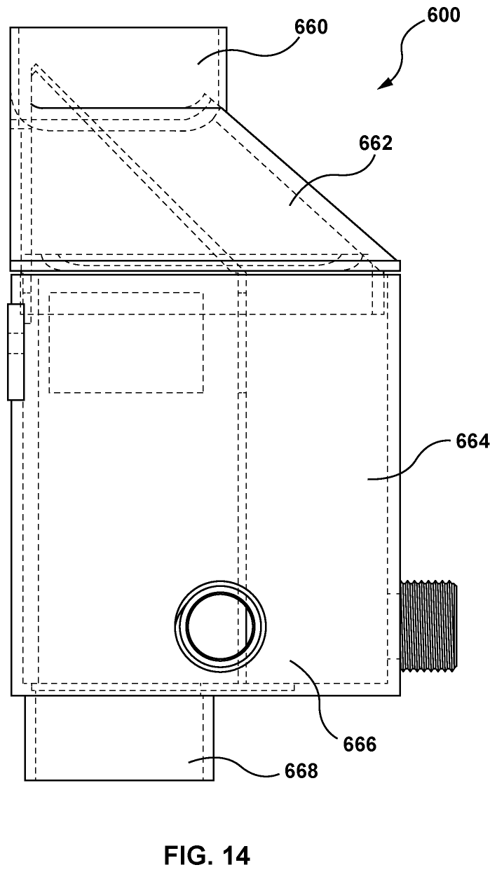

In another example, as shown in FIGS. 13 and 14, device 600 includes side walls 613 include a first upper portion 660 that couples to an upper downspout portion (not shown), a second upper portion 662 that is sloped outwardly and sloped laterally relative to the first upper portion 660, a middle portion 664 that is generally parallel to the first upper portion 660, and a first lower portion 668 that is generally parallel to the first upper portion 660. Here, a second lower portion 666 (see FIG. 14) couples the middle portion 664 to the first lower portion 668 and is perpendicular to both of the middle portion 664 and the first lower portion 668. It should be noted that the embodiment shown in FIG. 13 has increased capacity (relative to embodiments described above), which provides for greater water pressure buildup on the diverter outlets 130. The embodiment shown in FIG. 12 also provides for a larger overflow opening for heavy rainfall applications. In at least one embodiment, upper portion 662 of diverter 600 is removable (e.g. is a top cap) that can provide for accessing the inner cavity of diverter 600 (e.g. for disassembly and/or cleaning).

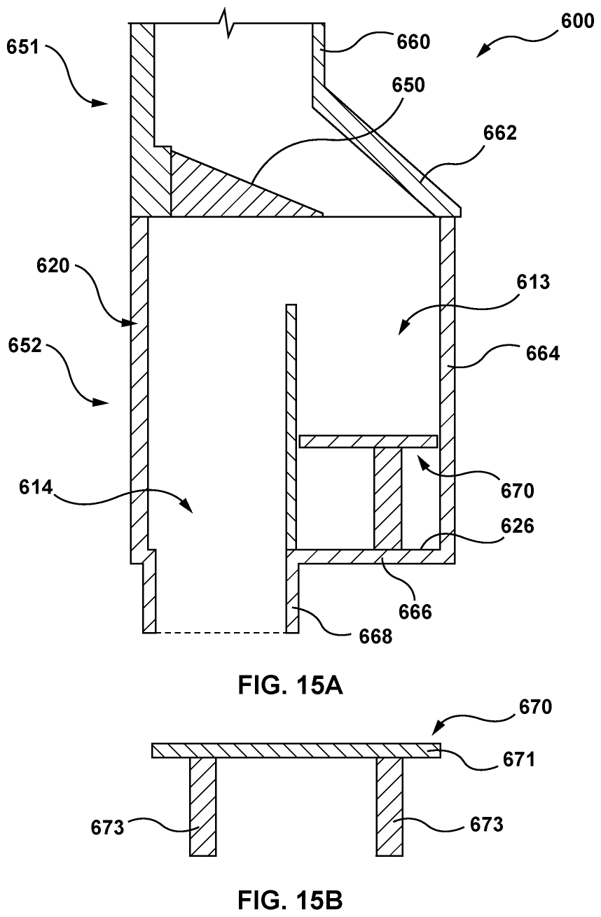

In another example, as shown in FIG. 15A, device 600 includes a first member 651 and a second member 652 configured to couple to the first member 651. First member 651 includes first upper portion 660. First upper portion 660 is a tubular conduit having an upper end sized to closely fit a lower end of an upper downspout section. The second member 652 first lower portion 668. First lower portion 668 is a tubular conduit having a lower end sized to closely fit an upper end of a lower downspout section.

First member 651 includes crown 650 extending inwardly from a rear wall of the device 600. Crown 650 is configured to direct water travelling downwardly from the upper downspout section laterally away from inner body 620, lower portion 668 and/or the lower downspout section. Water travelling downwardly through device 600 from an upper downspout section is redirected off of the crown 650 into cavity 613 at least partially surrounding (e.g. surrounding on at least three sides of) inner body 620 of the second member 652 and towards a collecting surface 626 of lower portion 666.

Crown 250 can have any shape or configuration to inhibit water travelling downwardly from an upper downspout section from directly entering inner body 620 without being directed into cavity 613. In the embodiments shown in FIG. 15A, crown 650 extends inwardly from a rear wall of the device 600 and slopes downwardly from the rear wall towards a front side of the device.

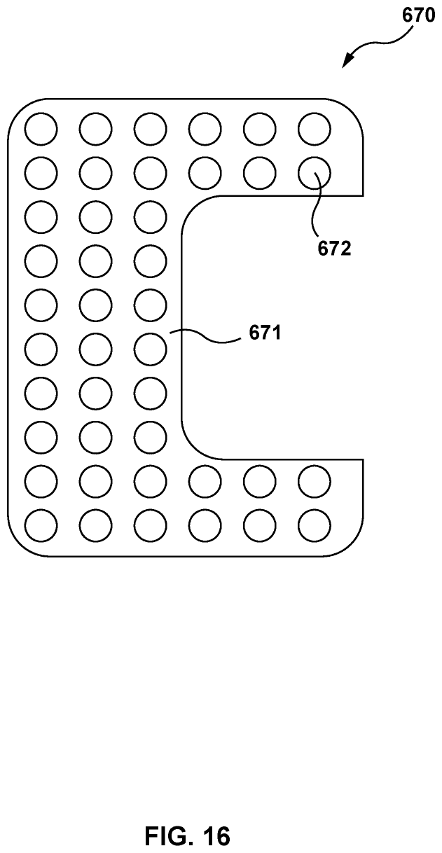

In the embodiment shown in FIG. 15A, device 600 also includes a filter 670. FIGS. 15B and 16 show a front view and a top down view, respectively, of filter 670, according to at least one embodiment. Filter 670 is sized and shaped to closely fit within cavity 624 and may be removable from the device 600 when first member 651 is removed from second member 652.

Filter 670 includes a platform 671 having a plurality of apertures 672 therein to provide for water to pass through the platform 671. Platform 671 is coupled to one or more posts 673 to provide for platform 671 to be spaced apart from collecting surface 626 of the device 600. As water and debris passes downwardly through device 600 from an upper downspout section, the water deflected by crown 650 away from inner body 620 towards an upper surface of the platform 671. Platform 671 is configured to provide for water to pass downwardly therethrough whereas large debris (i.e. debris that is larger than apertures 672), such as but not limited to leaves, sticks and the like, does not pass through the platform 671. Large debris is therefore collected on the platform 671. In at least one embodiment, posts 673 are configured to provide for the platform 671 to be positioned higher than the one or more outlets of device 600 to inhibit the debris from blocking and/or passing through and/or entering the outlets. Debris collected on the platform 671 can either be removed manually from the device 600 or, alternatively, may rise with rising water within cavity 613 and pass into a second cavity 614 of inner body 620 (e.g. over or though the inner walls of inner body 620 into second cavity 614) and downwardly through the inner body 620 and out the lower downspout section.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

What is claimed is:

1. A device for diverting water from a downspout, the device comprising:
a body having:
at least one outer side wall;
a top end having a top opening configured to couple to an upper portion of downspout to receive the water from the upper portion of downspout into a first cavity of the body;
a bottom end having a bottom opening configured to couple to a lower portion of downspout;
an outlet extending through one of the at least one outer side walls, the outlet configured to provide for at least a portion of the water to flow laterally out of the first cavity and through the one outer side wall;
a collecting surface positioned between the top end and the bottom end of the body, the collecting surface extending inwardly from the at least one outer side wall beneath the outlet; and
an inner body having one or more inner side walls inwardly spaced from the at least one outer side wall, the one or more inner side walls extending upwardly from the collecting surface above the outlet, the one or more inner side walls, the at least one outer side wall and the collecting surface forming the first cavity to divert the water away from the lower portion of the downspout and towards the at least one outlet.

2. The device of claim 1, wherein the collecting surface is a bottom surface of the first cavity.

3. The device of claim 1, wherein the collecting surface extends around at least two inner side walls of the inner body.

4. The device of claim 1, wherein the body further comprises a crown configured to direct water travelling downwardly from the upper portion of downspout towards the collecting surface.

5. The device of claim 4, wherein the crown is configured to direct water travelling downwardly from the upper portion of downspout into the first cavity.

6. The device of claim 4, wherein the crown is configured to inhibit water travelling downwardly from the upper portion of downspout from passing directly into the lower portion of downspout.

7. The device of claim 4, wherein the crown extends inwardly from at least one of the outer side walls.

8. The device of claim 1, wherein the inner body has three inner side walls inwardly spaced from respective outer side walls of the body.

9. The device of claim 8 having three outlets, each outlet including a fixture for receiving an end of a hose.

10. The device of claim 1, wherein the body has a rectangular shape.

11. The device of claim 1, wherein the inner body has a rectangular shape.

12. The device of claim 1 further comprising a filter configured to fit within the first cavity and inhibit debris from entering the at least one outlet.

13. The device of claim 12, wherein the filter includes a platform configured to provide for water to pass therethrough and inhibit debris from passing therethrough and one or more posts configured to support the platform at a position above the one or more outlets to inhibit the debris from entering the one or more outlets.

14. The device of claim 1, wherein the inner body defines a second cavity fluidly coupled to the first cavity and the lower portion of the downspout, the second cavity providing for water to pass from the first cavity and out of the device through the lower portion of the downspout.

15. The device of claim 14, wherein the inner side walls of the inner body separate the first cavity from the second cavity.

16. The device of claim 1, wherein the body includes a first member and a second member that is couplable to the first member.

17. The device of claim 1, wherein the collecting surface is perpendicular to the inner side walls.

18. The device of claim 1, wherein the collecting surface is perpendicular to the outer side walls.
